(19) United States
(12) Patent Application Publication
(10) Pub. No.: US 2012/0116931 A1
(43) Pub. Date: May 10, 2012

(54) Method for establishing an impromtu geofenced area to organize and analyze shipments

(75) Inventor: Richard C. Meyers, Longboat Key, FL (US)

(73) Assignee: System Planning Corporation, Arlington, VA (US)

(21) Appl. No.: 13/289,802

(22) Filed: Nov. 4, 2011

Related U.S. Application Data
(60) Provisional application No. 61/411,411, filed on Nov. 8, 2010.

(51) Int. Cl. G06Q 10/00

(52) U.S. Cl. 705/28

(57) ABSTRACT

A method of establishing a virtual perimeter for a real-world geographic area in which a zone is digitally customized to receive and disburse ad-hoc supplies including procedures for authorizing volunteers and other relief entities to draw supplies from the geo-fence zone utilizing wireless technology. The method of the present invention includes establishing geo-fences and communication links between the geo-fences to form a virtual warehouse. The present invention is well suited for disaster relief operations or other emergencies in which donated supplies require distribution throughout a widespread area of need.

### PRIORITY CLAIMS

The present invention claims priority to U.S. Provisional Patent Application No. 61/411,411, filed Nov. 8, 2010. No new matter has been added.

### BACKGROUND OF THE PRESENT INVENTION

1. Field of the Present invention

The present invention relates to a method of establishing an impromptu geo-fence to organize and analyze shipments of supplies. More specifically, the present invention relates to establishing a geo-fence in a disaster relief situation to establish a virtual warehouse in which priority relief supplies may be pushed to authorized clinics, stations, and distribution points.

2. Description of Related Art

Recently, numerous real world examples of devastating large scale disasters have highlighted the difficulty of organizing and distributing relief supplies and aid. The most recent example, the January 2010 Earthquake, Port Au Prince, Haiti, resulted in an overwhelming need in an extremely short time met by an overwhelming response that saturated a defined geographic area. Ten months after the Haitian Earthquake of early 2010, warehouses were reported as still full of relief supplies while Haitian victims were badly in need of these supplies. The present invention addresses the problem of receiving pallets of supply from ad hoc supply routes and quickly and efficiently organizing a geo-fence or virtual perimeter in which methods of accountability and command and control may be established to distribute commodities without delay.

The present state of the art has resulted in mounting frustrations as supply pallets are piled up by the ton in ravaged cities and reports circulate about water sitting in warehouses waiting for a United Nations (UN) or other aid organizations to distribute it. Since the priority of organizations on the ground in Haiti such as the UN World Food Program and Doctors' Without Borders is to get relief out to the needy people, a solution is needed to make supplies readily available to mitigate the suffering effected communities.

### SUMMARY OF THE PRESENT INVENTION

The present invention seeks to push all supplies from the tarmac to appropriate geo-fenced zones where databases and communication networks are established to inform preregistered authorized personnel about availability of supplies.

A geo-fence could be dynamically generated as in a radius around a store or point location. A geo-fence can also be a predefined set of boundaries, like school attendance zones or neighborhood boundaries. A user in a geo-fence area can receive generated notification. The user could register within the geo fenced area or preregister via website and receive authorization before departing for the disaster site. The user's mobile phone device or other location aware device will receive generated notification from the geo-fence database and control center. The user will also be able to submit a supply order by text via their mobile phone or other location aware device.

To address the problems and limitations noted above, a method for establishing an impromptu geo-fence for organizing and analyzing shipments is provided. The object of the present invention is to overcome the shortcomings disclosed in the prior art. The accompanying drawings, which are incorporated in and constitute part of the specification, illustrate various embodiments of the present invention and together with the description, serve to explain the principles of the present invention.

### BRIEF DESCRIPTION OF THE DRAWINGS

FIG. 1 is a flowchart diagram of a method for establishing a geo-fence perimeter zone according to an embodiment of the present invention.

FIG. 2 is a functional configuration according to an embodiment of the present invention.

FIG. 3 is an organizational table relating supply classes and authorized personnel categories.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art.

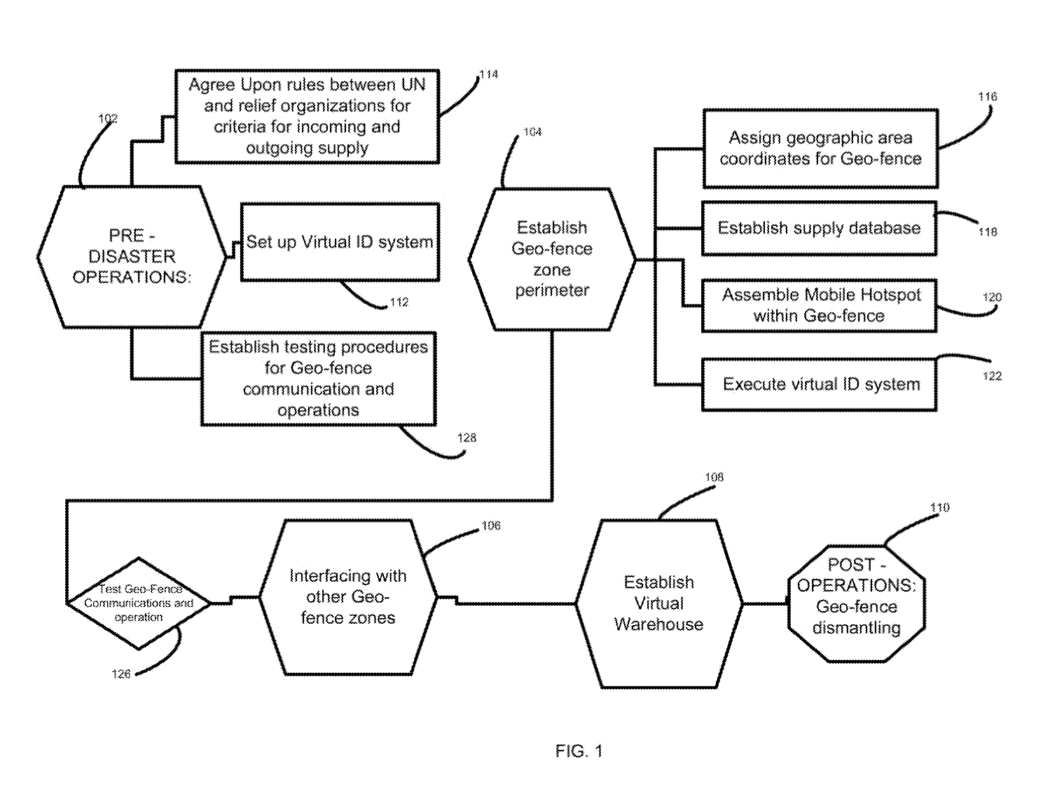

With reference now to FIG. 1, the basic method of the present invention may consist of at least 5 operational stages which will now be discussed. The five overall operational stages include: pre-disaster operations 102, establishing a geo-fence zone and operations within the geo-fence 104, interfacing with other geo-fence zones 106, establishing a virtual warehouse 108, and lastly, post operational procedures 110 necessary to dismantle the geo-fence upon completion of the disaster relief operational situation.

As shown in FIG. 1, the first operational stage, pre-disaster operations 102 entails a process for pre-establishing rules and procedures to be agreed upon between UN authorities and relief organizations based on international laws and criterion for incoming and outgoing supplies 114, establishing a virtual identification and authentication system 112, and establishing guidelines and standard operating procedures within a geo-fence such as testing procedures and protocols for communications and daily operations 128.

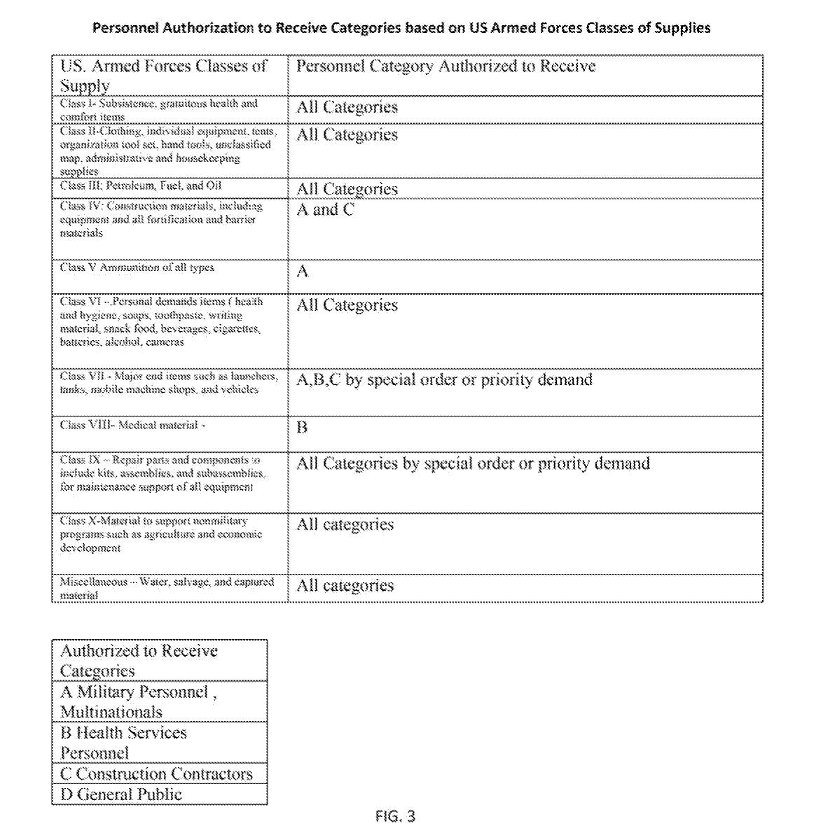

The virtual identification and authorization system 112 will enable registered users to receive notification of supply arrivals and updates as well as place supply orders via text or some other location based device. Preferably, an emergency responder's website will be established during the pre-disaster operations stage 102 and made accessible for immediate registration for the duration of the disaster. Also preferably, registration applications may undergo screening and complete background checks before a candidate is qualified as a volunteer. The virtual identification and authorization system 112 may store the Mobile phone identification number (MIN) of the user to instantly authenticate a user. These security measures may help ensure that the authorized user has immediate access to the supplies and commodities in the specific supply classes they are authorized to draw from based on their category qualification (See discussion of FIG. 3 for more detail on qualification categories).

As further shown in FIG. 1, the second operational stage in the present invention, establishing a geo-fence zone perimeter 104, may preferably be initiated as an immediate response to assessing the extent of damage on the ground. Preferably, designating the geographic coordinates of the location of the geo-fence 116 may be assigned high priority. Ideally, the national authorities will work in conjunction with the United Nations officials to establish the geo-fence zones. However, in the absence of any civil authority or national military authority, the immediate responders may establish geo-fence operations and report the geographic area coordinates of each geo-fence zone to acting authorities. Preferably, after the location of the geo-fence is established, the priority will shift to simultaneously establishing a supply database 118, assembling a mobile hot-spot within the geo-fence 120 and executing the previously established virtual identification system 122. Testing the geo-fence communication and operational systems 126 preferably may begin no later than 48 hours after reporting geographic area coordinates and should follow specific guidelines that were pre-established in the pre-disaster operation stage 102.

According to a preferred embodiment of the present invention, each geo-fence zones should begin interfacing databases and communication systems with other geo-fence zones 106 already established in the wider operational area. The purpose of this operational stage is to ensure that the appropriate needs of providers and victims throughout the entire relief area operations are most efficiently met by creating a wider system of supply and demand.

As further shown in FIG. 1, the operational stage of establishing a virtual warehouse system 108 for the purpose of incorporating the local merchant supply system and commercial warehouses into the relief operations is provided. The overarching aim of establishing a virtual warehouse system is to establish an item level inventory manageable from the decision-making level. According to one aspect of the present invention, a plan for shifting the responsibility of managing the operational demands of the virtual warehouse to the local authorities may be implemented. The details of a virtual warehouse system, as disclosed in the Provisional Patent Application No. 61/411,282 titled System and Apparatus for Item Level Inventory Management Within A Virtual Warehouse, is hereby incorporated by reference.

In a virtual warehouse system product will be identified by item number for each item stored on an RFID tag preferably as small as 0.3 mm/chip. The identifying data and location of each item will be transmitted to a central database which will be accessible from a high level and viewed in real time based on the automatic data capture capability of the RFID reader/GPS devices which are integral in the virtual warehouse model. Therefore, the boundaries of a virtual warehouse may be defined by disaster sites, military operational zones, pre-planned and/ or prepositioned storage containers, a group of commercial or government warehouse facilities, or a combination of any of the above. In addition, the design of the virtual warehouse can be rearranged quickly to meet new needs in a new location because of the real time tracking system accessible to high level decision makers.

The operations of the geo-fence zones within the virtual warehouse can be managed indefinitely. However, when disaster relief operations are terminated, it may be necessary to dismantle the Geo-fence area 116. Preferably the procedures for this stage are also pre-established in the operation guidelines 128.

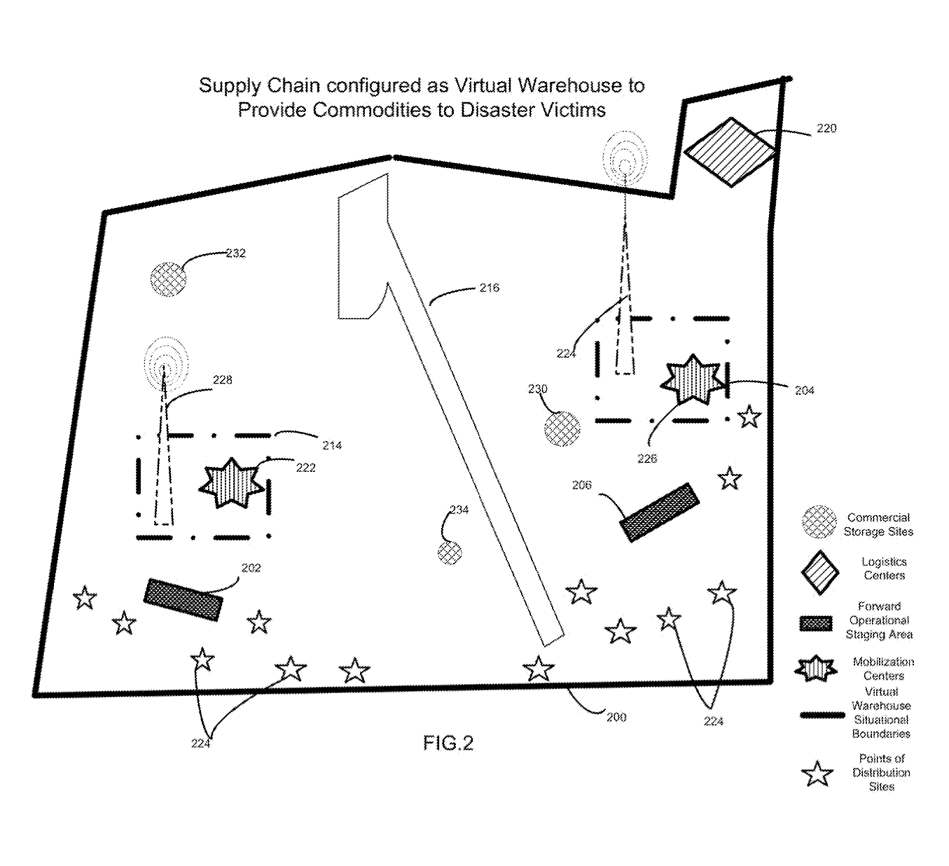

With reference now to FIG. 2, a functional configuration according to an embodiment of the present invention will now be discussed. As show in FIG. 2, a map of a supply chain configured within the boundary of a virtual warehouse 200 to provide commodities to disaster victims. The supply chain comprises a logistics center which is based within the Continental United States (CONUS) 220, a disaster relief operational area located in Other Than The Continental United States (OCONUS), a main airport closest to the epicenter of the disaster 216, two established geo-fence zones, one east of the airport 204 and one west of the airport 214. As also shown in the virtual warehouse 200 there are several commercial warehousing facilities: 2 finished goods warehouses 232 and 230 and a refrigerated warehouse that produces and stores ice 234. As further shown, within both geo-fence zones, there are mobile hotspots 224 and 228.

As shown in FIG. 2, mobilization centers 226 and 222, which oversee the supply chain operations in each respective forward operational staging area 206 and 202. The forward operational staging areas 206 and 202 are designed to hold 1-2 days of supplies which will meet resupply demands at designated points of distribution 224. In accordance with a preferred embodiment of the present invention, the forward operational staging areas and the mobilization centers responsibilities may be truncated or deleted altogether within the virtual warehouse as the main roles of these entities may be excessively redundant in the virtual warehouse, hampering overall operational effectiveness. In any case, the existence of a forward staging area and mobilization center may or may not be deemed warranted and as such are not necessary within a virtual warehouse model.

Operating a supply chain within a virtual warehouse system 200 requires all items to be labeled with a RFID tag with embedded identifier code including expiration date and other pertinent information. All sites and centers have RFID reader/GPS devices transmitting to the central databases and logistics centers 220. Preferably, all logistics centers can initiate an automatic date capture from any individual site or on a regularly scheduled preprogrammed basis. Also preferably, RFID tags are programmable in order to be updated as the situation demands.

As shown in FIG. 3, a pre-established table for supply authorization specifying a category for personnel based on their qualifications and area of responsibility. The four different categories established for personnel authorized to receive supplies are as follows: Category A—Military Personnel and Multinationals, Category B—Health Service Personnel, Category C—Construction Contractors, and Category D—General Public. As previously detailed, all authorized volunteers will be assigned designated categories which will determine the classes of supplies they are authorized to receive. According to a preferred embodiment of the present invention, all supplies entered into the geo-fence supply database may be classified according to the standard U.S. Armed Forces Classes of Supply. Preferably, the security information embedded on the RFID tag includes the supply class designation.

Communication System

In accordance with a preferred embodiment of the present invention, the reporting may be made via a wireless connection to a satellite mode to communicate with a satellite system such as Globalstar or Orbcomm. Preferably, such a satellite device will be a device such as the Axxon, AutoTracker, or the like, or a customized Orbcomm VHF satellite GPS tracking communications device which may be adapted with Zigbee interface antenna devices to incorporate them into the overall LAN architecture of the security system; these devices include a satellite transceiver, GPS receiver, a customized Zigbee wireless antenna with a serial (Ax Tracker) or duplex (OrbComm) interface.

In accordance with an alternative preferred embodiment of the present invention, the reporting may also be made'using a wireless system independent from the satellite system. According to this embodiment, wireless signals may be transmitted to a wireless relay, base station or the like for routing and transmission to a chosen centralized location independent from or in combination with the transmissions made from the satellite system. In accordance with this alternative embodiment, signals may also be received by the communications manager and wireless interface from such external wireless networks as well.

According to a preferred embodiment of the present invention, it is preferred that the wireless communications used within the present invention will be based on the Zigbee (IEEE 802.15.4) standard. This standard transmits RF signals in the 2.4 GHz ISM band and operates with low power consumption due to its relatively slower data transmission rate (128 Kpps-250 Kbps). This approach enables additional capacity and flexibility of design through an up to 255 node pico-network. Communications are simplex or duplex in design, meaning that data can be assessed in either a push or pull process.

As referred to above, all communications of the present invention may be designed to be duplex or simplex in nature. Further, as needs require, the processes for transmitting data to and from the present invention may be designed to be push or pull in nature. Still, further, each feature of the present invention may be made to be remotely activated and accessed from distant monitoring stations. Accordingly, data may preferably be uploaded to and downloaded from present invention as needed. For example, as detailed above, each system and subsystem of the present invention may be designed to send, receive, report and request information via the wireless and/or satellite systems so as to continually maintain and update the container systems.

Additional communications with the communications manager are preferably enabled via industry standard wired interfaces, with communications protocols implemented in firmware for future upgrade. These interfaces preferably will include at least two RS-322 compatible serial ports. These alternate serial ports may assist the communications manager to interface with additional remote sensors as well as other local reader/controllers such as an RFID reader or other devices.

Remote Monitoring

To support and monitor the dataflow generated by the present invention, it is preferred that users establish a centralized location to collect and analyze data. This central location or “data fusion center” would preferably consolidate all tracking signals, sensor alarms and reports generated by the monitoring systems and provide further context and links with current intelligence.

Preferably, such a data fusion center will receive such source information in a variety of formats such as Electronic Data Interchange, XML, E-mail, HTML and flat text files. After receiving such data, the data fusion center preferably would act to process information to identify anomalies. With this data collected and processed, analyst may calculate statistics and probability of detection models used for decision support. In short, such a data fusion center would preferably provide a consolidated source of information that could be used to assist agencies and shippers.

What is claimed is:

1. A method of establishing an impromptu geo-fence to organize and distribute supplies, the method comprising:
assigning coordinates demarking a geo-fenced area within a larger geographic area;
establishing a supply database for recording location and type of selected equipment and materials within the geofenced area;
determining supply needs within the geofenced area;
identifying locations of specific points of need within the geofenced area; and
establishing central location points within the geofenced area which minimize distance to points of need within the geofenced area.

2. The method of claim I, wherein the step of establishing central location points comprises calculating energy required for travel between multiple points and selecting at least one central location point which minimize the energy required for travel between points of need and the selected central location point.

3. The method of claim 2, wherein the method further comprises determining weight and mode of transportation for types of selected equipment and materials within the geofenced area.

4. The method of claim 3, wherein the method further comprises recalculating location of central location points based on modes of transportation available.

5. The method of claim 4, wherein the method further comprises providing one or more mobile hotspots within the geofenced area.

6. The method of claim 5, wherein the method further comprises tagging selected equipment and materials within the geofenced area with an RFID chip and updating the supply database with the real time locations of the tagged items.

7. The method of claim 6, wherein the method further comprises updating supply needs and updating geofence coordinates based on updated supply needs.

8. The method of claim 7, wherein the method further comprises identifying adjacent geofenced areas.

9. The method of claim 8, wherein the method further comprises requesting supply data from adjacent geofenced areas.

10. The method of claim 9, wherein the method further comprises establishing a virtual warehouse within an identified region which is supplied by a supply chain.

11. The method of claim 10, wherein the method further comprises the steps of
receiving RFID data from items within the supply chain;
receiving need data regarding supply needs within an identified region;.
comparing RFID data and need data;
establishing a geofenced area based on the RFID data and the need data;
generating requests for supplies to be transported into the geofenced area based on RFID data and need data;
updating RFID data and need data; and
redefining the geofenced area based on updated RFID data and need data.

12. The method of claim 11, wherein the method further comprises receiving geographic data and adjusting the geofenced area based on the geographic data.

13. The method of claim 12, wherein the method further comprises:
receiving and updating data regarding traffic patterns; and
redefining the geofenced area based on updated data regarding traffic patterns.

14. An apparatus for establishing an impromptu geo-fence to organize and distribute supplies a virtual warehouse and for managing a supply chain within an identified region, the apparatus comprising:
a receiving element for receiving RFID data and data regarding supply needs within an identified region; and
a processor configured to analyze RFID data and data regarding supply needs, wherein the processor is further configured to establish a geofenced area based on received data and to generate requests for supplies to be transported into the geofenced area based on received data.

15. The apparatus of claim 14, wherein the processing element is further configured to:
assign coordinates demarking a geo-fenced area within a larger geographic area;
establish a supply database for location and type of selected equipment and materials within the geofenced area;
determine supply needs within the geofenced area;
identify locations of specific points of need within the geofenced area; and
establish central location points within the geofenced area which minimize distance to points of need within the geofenced area.

16. The apparatus of claim 15, wherein the receiving element is further configured to receive updated RFID data and updated data regarding supply needs; and further wherein, the processor is further configured to adjust the geofenced area based on the updated data.

17. The apparatus of claim 16, wherein the RFID data is obtained from the group consisting of: an RFID tag, an embedded chip, a smart label or an intelligent barcode.

18. The apparatus of claim 17, wherein the RFID tag is passive, semi-passive or active.
